(19) United States
(12) Patent Application Publication
(10) Pub. No.: US 2025/0099321 A1
(43) Pub. Date: Mar. 27, 2025

(54) Combined-Type Massager

(71) Applicant: Chuwen LIN, Guangdong (CN)

(72) Inventor: Chuwen LIN, Guangdong (CN)

(21) Appl. No.: 18/956,523

(22) Filed: Nov. 22, 2024

(51) Int. Cl. A61H 19/00; A61H 9/00; A61H 23/02

(52) U.S. Cl. CPC A61H 19/34; A61H 9/0057; A61H 19/44; A61H 23/0218; A61H 2201/1685; A61H 2201/169

(57) ABSTRACT

A combined-type massager comprises a telescopic massage element and a sucking massage element, wherein the sucking massage element has at least two opposite end parts; each of the two end parts is provided with a sucking part and a negative pressure cavity, and at least part of the sucking part is located in the negative pressure cavity; the sucking part has a concave structure and is configured as a sucking cavity, and a movable tongue part is provided in the sucking cavity; the sucking massage element is provided with a telescopic part capable of expanding and contracting.

### TECHNICAL FIELD

The present disclosure relates to the technical field of massagers, in particular to a combined-type massager.

### BACKGROUND

With the improvement of living standards and the increasing pressure of people's life and work, massagers are welcomed by more and more people because they can meet the needs of the body and release pressure. Among them, the sucking massager can simulate the sucking action, so as to suck and massage the sensitive parts of the human body. It has a high comfortness, and thus has been favored by the majority of female users.

The existing U.S. patent No. 20220296459 discloses a “FLOWER-SHAPED MASSAGER HAVING TRANSPARENT HOUSING”. The massager of this patent can perform sucking massage. However, the patent only has the function of sucking and massaging, and its single function can hardly meet the needs of different users, and thus the applicability thereof is not high.

Therefore, there is a need to put forward a new type of sucking massager, which has multiple functions and has a better massage effect, which is more adapted for the satisfying needs of different users.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present disclosure provides a combined-type massage device to solve that problem that the sucking massager has a single function.

In order to achieve the above object, the present disclosure provides a combined-type massager, which includes a telescopic massage element and a sucking massage element; the sucking massage element has at least two opposite end parts, each of the two end parts is provided with a sucking part and a negative pressure cavity, and at least part of the sucking part is located in the negative pressure cavity; the sucking part has a concave structure and is configured as a sucking cavity, and a movable tongue part is provided in the sucking cavity; the sucking massage element is provided with a telescopic part capable of expanding and contracting, and the telescopic part is inserted into the negative pressure cavity and detachably connected with the negative pressure cavity; when the telescopic part is expanded and contracted, the negative pressure cavity and the sucking cavity generate an air pressure difference, and are able to drive the tongue part to move; and when the telescopic massage element is separated from the sucking massage element, the telescopic massage element is adapted for being configured for massage alone.

The present disclosure further provides a combined-type massager, which includes a sucking massage element; the sucking massage element has at least two opposite end parts, each of the two end parts is provided with a sucking part and a negative pressure cavity, and at least part of the sucking part is located in the negative pressure cavity; the sucking part has a concave structure and is configured as a sucking cavity, and a movable tongue part is provided in the sucking cavity; a telescopic device capable of expanding and contracting is inserted into the negative pressure cavity, and the telescopic device is detachably connected with the negative pressure cavity; and when the telescopic device is expanded and contracted, the negative pressure cavity and the sucking cavity generate an air pressure difference, and are able to synchronously drive the tongue part to move.

The present disclosure further provides a combined-type massager, which includes a sucking massage element; the sucking massage element has at least two opposite end parts, each of the two end parts is provided with a sucking part and an installation cavity, and at least part of the sucking part is located in the installation cavity; the sucking part has a concave structure and is configured as a sucking cavity, and a movable tongue part is provided in the sucking cavity; a telescopic device capable of expanding and contracting is inserted into the installation cavity, and the telescopic device is detachably connected with the installation cavity; the telescopic device is provided with a telescopic part, and a linkage mechanism is provided between the telescopic part and the tongue part; and when the telescopic part is expanded and contracted, the telescopic part is connected with the tongue part through the linkage mechanism and synchronously drives the tongue part to move.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic structural diagram of the whole present disclosure.

FIG. 2 is a schematic structural view from another perspective of FIG. 1.

FIG. 3 is a sectional view of FIG. 1.

FIG. 4 is a partially enlarged schematic diagram at A of FIG. 3.

FIG. 5 is a schematic structural view of FIG. 1 when it is separated.

FIG. 6 is a schematic structural view of the sucking massage element in FIG. 1.

FIG. 7 is a schematic structural view from another perspective of FIG. 6.

Reference signs: Telescopic massage element (100); Intra-body massage element (101); Telescopic part (1011); Telescopic motor (1012); Magnetic body (1013); Extra-body massage element (102); First vibration motor (1021); Sucking massage element (200); Sucking part (201); Sucking cavity (202); Tongue part (203); Tongue root part (2031); Second vibration motor (204); Negative pressure cavity (205); Air hole (206); Installation cavity (207).

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

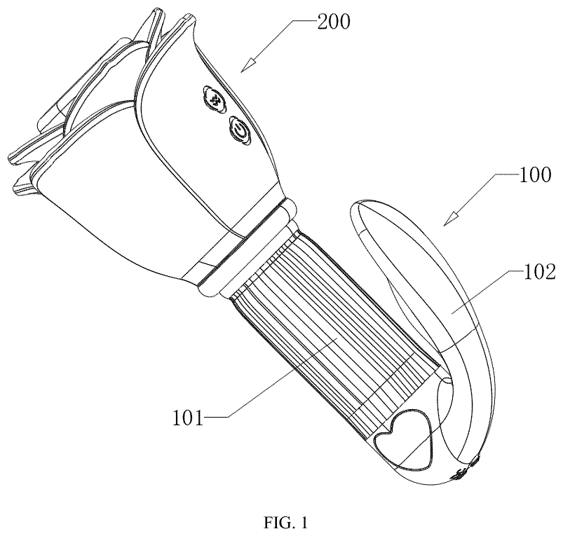

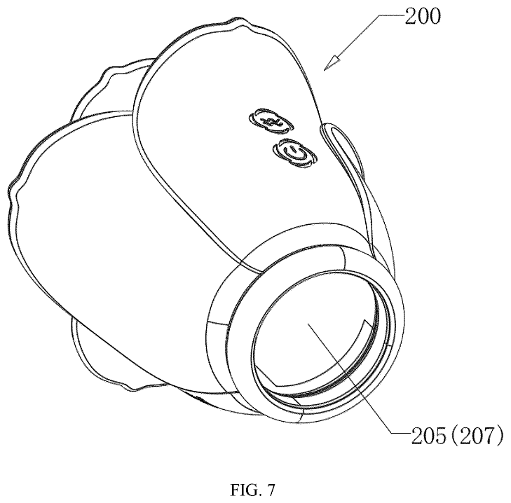

Please refer to FIGS. 1 to 7;

The present disclosure provides a telescopic massage element 100 and a sucking massage element 200. The sucking massage element 200 has at least two opposite end parts, and each of the two end parts is provided with a sucking part 201 and a negative pressure cavity 205, and at least part of the sucking part 201 is located in the negative pressure cavity 205. The sucking part 201 has a concave structure and is configured as a sucking cavity 202, and a movable tongue part 203 is provided in the sucking cavity 202.

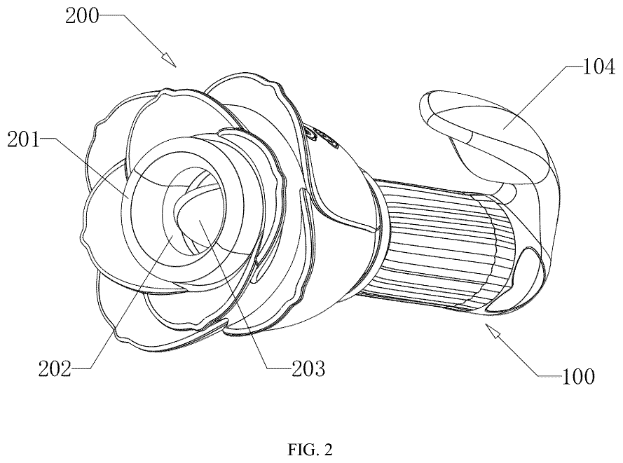

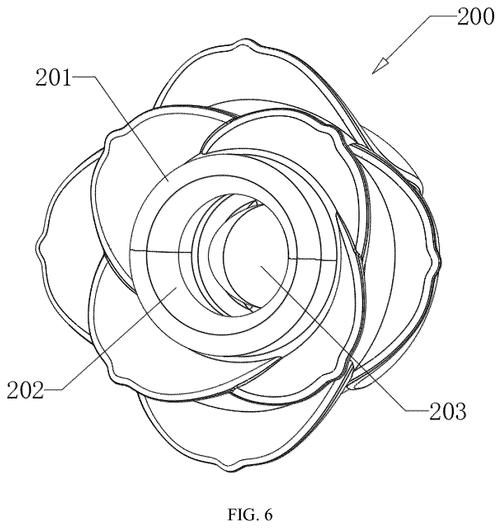

As shown in FIG. 2 and FIG. 6, in this embodiment, the sucking part 201 is made of a flexible silicone material, and the top of the negative pressure cavity 205 is configured to have an annular shape with an arc chamfer, so that the negative pressure cavity 205 can cover the part of the human body that need to be massaged, such as the chest, vulva or clitoris.

By designing the top end of the negative pressure cavity 205 to be an annular structure, it can more effectively fit the curved surface of human skin and achieve a more compact sealing effect. As such, it is ensured that the sucking effect can be significantly improved and a better use experience can be achieved during the period of sucking action.

The shape and outline of the sucking part 201 are not limited to those in the drawings, and in other embodiments (not shown), corresponding shapes may also be configured for specific parts.

For example, the sucking part 201 and the sucking cavity 202 are designed in an elongated cavity shape. By the configuration of an elongated cavity shape, the sucking part 201 can be sleeved on a man's penis and suck and massage the penis, while the tongue part 203 can vibrate and/or reciprocate, thereby stimulating and massaging the glans of the penis. Furthermore, in this way, the combined-type massager can also be adapted for massaging of the male genital organ.

For example, the top of the sucking cavity 202 is annularly shaped to be more suitable for the female vulva, so that the sucking part 201 is more closely attached to the vulva, which makes the user more comfortable to use and improves the user's experience.

In this embodiment, there is a gap between the tongue part 203 and the inner wall of the sucking cavity 202, which aims to provide a sufficient and flexible moving area for the tongue body, so that when the sucking part 201 performs the sucking massage function, this allows the tongue part 203 to vibrate or move in various forms more freely, including but not limited to dynamic actions such as swinging and stretching. In this way, in the process of sucking massage, the tongue part 203 can not only make a follow-up response, but also exert additional stimulating effect on the massage area, thus further enhancing the massage effect and improving the overall comfort.

In this embodiment, the sucking massage element 200 is provided with a telescopic part 1011, which is inserted into the negative pressure cavity 205 and detachably connected with the negative pressure cavity 205. When the telescopic part 1011 expands and contracts, the negative pressure cavity 205 and the sucking cavity 202 generate an air pressure difference, and can drive the tongue part 203 to move. When the telescopic massage element 100 is separated from the sucking massage element 200, the telescopic massage element 100 can be configured for massage alone.

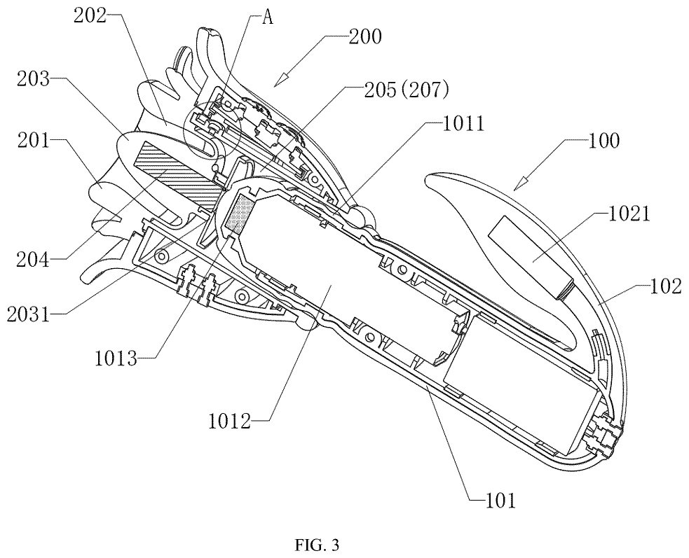

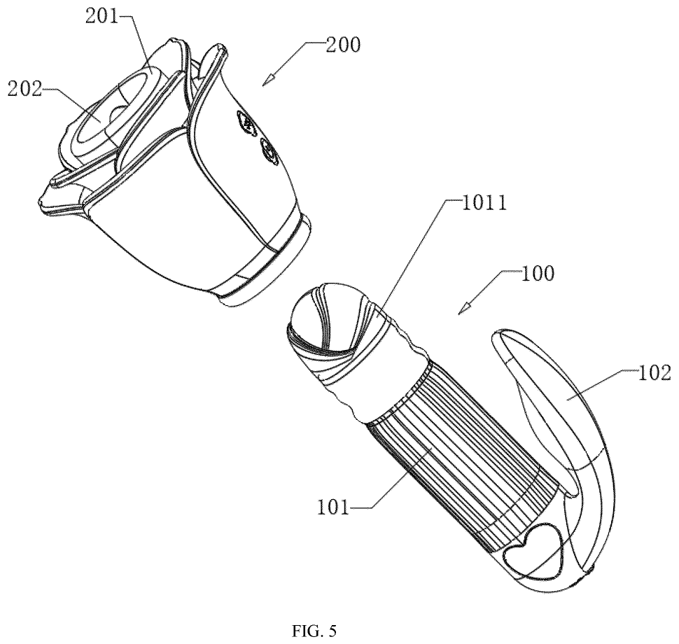

As shown in FIGS. 3 and 5, in this embodiment, the telescopic massage element 100 is a massage stick, which can be detached from the sucking massage element 200 and inserted into a body cavity for massage, such as vagina and anus.

The telescopic massage element 100 includes an intra-body massage element 101, and the telescopic part 1011 is disposed at the edge of an end of the intra-body massage element 101. The intra-body massage element 101 is provided with a telescopic driving mechanism for driving the telescopic part 1011 to expand and contract.

In this embodiment, the telescopic driving mechanism is a telescopic motor 1012, which extends to the telescopic part 1011 and drives the telescopic part 1011 to expand and contract. After the telescopic motor 1012 is energized and started, it can perform a telescopic action. Among them, the telescopic motor 1012 is a well-known technology in the field, and the working principle of the telescopic motor 1012 will not be described in detail in this application.

When the telescopic motor 1012 expands and contracts, the telescopic motor 1012 can drive the telescopic part 1011 to expand and contract, so that when the telescopic massage element 100 is inserted into the body cavity, the body cavity can be telescopically massaged.

The telescopic part 1011 is not limited to being driven to expand and contract by the telescopic motor 1012. In other embodiments (not shown) of its telescopic driving mechanism, the telescopic driving mechanism can also be a crank-slider mechanism, an eccentric wheel mechanism, a cam mechanism, a crank-connecting rod mechanism, a piston assembly, a maltese mechanism and the like, and the telescopic part 1011 can also be driven to expand and contract through these reciprocating transmission mechanisms.

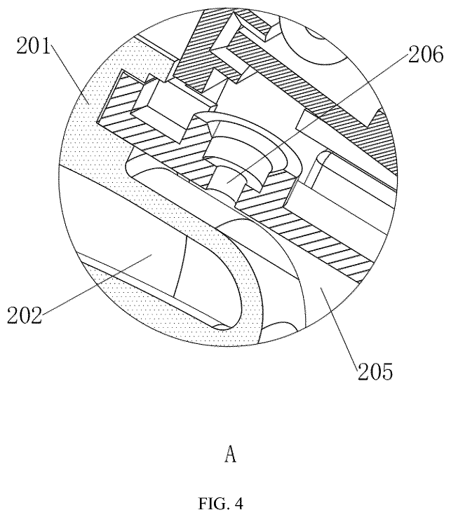

According to the above, as shown in FIGS. 3 and 4, in this embodiment, the end of the negative pressure cavity 205 far from the sucking part 201 is an open end, and the telescopic part 1011 is inserted into the negative pressure cavity 205 via the open end. When the telescopic part 1011 is inserted into the negative pressure cavity 205, the telescopic part 1011 and the open end are attached to each other to form a sealed structure. An end of the negative pressure cavity 205 close to the sucking part 201 is provided with an air hole 206, which is configured for air sucking and exhausting when the telescopic part 1011 expands and contracts. When the telescopic part 1011 is in an expanded state, the air in the negative pressure cavity 205 is exhausted; when the telescopic part 1011 is in a contracted state, the negative pressure cavity 205 forms a negative pressure and generates a pressure difference with the sucking cavity 202.

The outer surface of the intra-body massage element 101 is made of soft silica gel, so that when the telescopic massage element 100 is inserted into the negative pressure cavity 205, the surface of the intra-body massage element 101 can closely adhere to the open end of the negative pressure cavity 205 and form a sealed structure.

Therefore, when the combined-type massager is used for massage, the sucking part 201 of the sucking massage element 200 is first covered on the body part to be massaged. Then, the telescopic part 1011 of the telescopic massage assembly is inserted into the negative pressure cavity 205, and the telescopic part 1011 is started to perform a telescopic action. With the dynamic expansion and contraction of the telescopic part 1011, the internal volume of the negative pressure cavity 205 changes accordingly.

Specifically, when the telescopic part 1011 is in an expanded state, it will effectively compress the air in the negative pressure cavity 205, forcing this air to be discharged to the external environment through the preset air hole 206. In this process, the compressed air will form a driving force, which will drive the tongue root part 2031 of the tongue part 203 to move towards the opening of the sucking cavity 202. On the contrary, when the telescopic part 1011 contracts, the internal space of the negative pressure cavity 205 is expanded accordingly, which leads to a significant decrease in the air pressure in the cavity, and further forms an obvious air pressure difference between the negative pressure cavity and the sucking cavity 202. This air pressure difference will push the tongue part 203 in the opposite direction and make it move towards the negative pressure cavity 205.

The tongue part 203 is synchronously driven to reciprocate by the periodic telescopic action of the telescopic part 1011. While the tongue part 203 performs this series of reciprocating movements, the air in the sucking cavity 202 will also be squeezed and discharged to the outside, so that the interior of the sucking cavity 202 will also form a negative pressure state. As such, the sucking part 201 can effectively suck and massage the sensitive part of the human body.

It is worth noting that in the whole process of sucking massage, the reciprocating motion of the tongue part 203 can stimulate the massage element by slapping and kneading, further improving the overall effect of massage. This multi-massage method, which combines sucking, tapping and kneading, brings users a more comprehensive massage experience.

The massage mode of the tongue part 203 is not limited to the above-mentioned flapping and kneading massage mode, but in other embodiments (not shown), the tongue part 203 can also be designed to perform a licking massage action in a reciprocating manner, for example, the tongue part 203 can reciprocate up and down or left and right to perform the licking massage action. Therefore, by setting the tongue part 203 into different action forms, the massage needs of different users can be satisfied.

If the telescopic massage element 100 needs to be used for massage, it is only necessary to pull out the telescopic massage element 100 from the negative pressure cavity 205 and then insert it into the body cavity for massage. In this embodiment, the telescopic massage element 100 further includes an extra-body massage element 102, the telescopic part 1011 is disposed at one end far away from the extra-body massage element 102, and a first vibration motor 1021 is installed in the extra-body massage element 102.

By providing the extra-body massage element 102, when the intra-body massage element 101 is inserted into a body cavity for massage, the extra-body massage element 102 can contact with a part outside the body, e.g., clitoris, for massage. On the other hand, by providing the first vibration motor 1021, vibration massage can be performed on the part outside the body.

Of course, the extra-body massage element 102 is not limited to vibration massage. In other embodiments (not shown), the extra-body massage element 102 can be equipped with a swing drive device, which can drive the extra-body massage element 102 to swing in a reciprocating manner, so as to massage the part outside the body, and improve the massage effect and use experience.

Of course, the intra-body massage element 101 can also be provided with a protrusion part (not shown) close to the intra-body massage element 101. The inside of the intra-body massage element 101 is also provided with a swing driving device corresponding to the protrusion part, and the swing driving device can drive the protrusion part to swing in a reciprocating manner, so that when massaging the body cavity, the protrusion part that swings in a reciprocating manner can pat and massage sensitive parts in the body cavity, e.g., vaginal G-spot, so that the massage effect can be further improved and the user experience can be improved.

In other embodiments (not shown), the telescopic massage element 100 is not limited to the form of a massage stick, but also can be replaced by a telescopic device with a telescopic function or other telescopic massage devices, for example a massage gun, a telescopic back massager, etc., so that parts outside the body can be massaged. Thereby, different telescopic massage elements 100 can be selected according to the market demand and the needs of different users.

As shown in FIG. 3, in order to improve the massage effect of the sucking massage element 200, in a further embodiment of this embodiment, a magnetic body 1013 is embedded in an end of the telescopic part 1011 closest to the sucking part 201. The tongue part 203 is provided with at least one tongue root part 2031, which extends to the negative pressure cavity 205 and is coaxially disposed with the telescopic part 1011. A second vibration motor 204 is embedded in the tongue part 203, the second vibration motor 204 has a built-in magnet, and the second vibration motor 204 penetrates the tongue root part 203 1 and is attracted by the magnetic body 1013.

By providing the second vibration motor 204 in the tongue part 203, the tongue part 203 can vibrate during sucking massage, thereby further improving the stimulation effect.

The magnetic body 1013 can be a magnet or a ferromagnetic material, and the magnet equipped in the second vibration motor 204 has the ability to attract each other with the magnetic body 1013 component. On the other hand, if the second vibration motor 204 is made of a ferromagnetic material, the magnetic body 1013 component needs to adopt a magnet to ensure effective magnetic attraction between them.

As such, when that telescopic part 1011 is inserted into the negative pressure cavity 205, the head end of the telescopic part 1011 can be closely attached to the tongue root part 2031 of the tongue part 203 by magnetic attraction, and a stable linkage structure is for. This structure makes it possible to directly and efficiently drive the tongue part 203 to reciprocate when the telescopic part 1011 performs the telescopic action. Due to the stability of the magnetic connection, the reciprocating motion amplitude of the tongue part 203 is significantly increased, so that a stronger stimulating effect is released in the process of flapping and kneading massage, and the overall massage effect of the sucking massage element is further enhanced.

Of course, in other embodiments, the telescopic part 1011 and the negative pressure cavity 205 may not be sealed, and the negative pressure cavity 205 no longer has negative pressure, but is configured as an installation cavity 207. Therefore, after the telescopic part 1011 is inserted into the installation cavity 207, the tongue part 203 can be directly driven to reciprocate by the linkage mechanism, and the flapping and kneading massage can be realized.

The linkage mechanism between the telescopic part 1011 and the tongue part 203 is certainly not limited to the magnetic connection. In other embodiments (not shown), the linkage mechanism between the telescopic part 1011 and the tongue part 203 may also adopt a bonding mode. Similarly, any applicable detachable connection modes such as clamping and threaded connection may also be adopted.

The present disclosure is provided with related supporting elements including a storage battery, a control panel, control buttons and the like, thereby realizing the electric massage function. The above structure belongs to the well-known technology in the field, and thus will not be described in detail in this application.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A combined-type massager, comprising a telescopic massage element and a sucking massage element, wherein
the sucking massage element has at least two opposite end parts, each of the two end parts is provided with a sucking part and a negative pressure cavity, and at least part of the sucking part is located in the negative pressure cavity;
the sucking part has a concave structure and is configured as a sucking cavity, and a movable tongue part is provided in the sucking cavity;
the sucking massage element is provided with a telescopic part capable of expanding and contracting, and the telescopic part is inserted into the negative pressure cavity and detachably connected with the negative pressure cavity; and
when the telescopic part is expanded and contracted, the negative pressure cavity and the sucking cavity generate an air pressure difference, and are able to drive the tongue part to move; and
when the telescopic massage element is separated from the sucking massage element, the telescopic massage element is adapted for being configured for massage alone.

2. The combined-type massager according to claim 1, wherein the telescopic massage element comprises an intra-body massage element, and the telescopic part is disposed at an edge of one end of the intra-body massage element.

3. The combined-type massager according to claim 2, wherein the intra-body massage element is provided with a telescopic driving mechanism, which is configured for driving the telescopic part to expand and contract.

4. The combined-type massager according to claim 1, wherein a magnetic body is embedded in one end of the telescopic part close to the sucking part.

5. The combined-type massager according to claim 4, wherein the tongue part is provided with at least one tongue root part, which extends to the negative pressure cavity and is coaxially disposed with the telescopic part.

6. The combined-type massager according to claim 5, wherein a second vibration motor is embedded in the tongue part, a magnet is embedded in the second vibration motor, and the second vibration motor penetrates the tongue root part and is attracted by the magnetic body.

7. The combined-type massager according to claim 1, wherein an end of the negative pressure cavity far from the sucking part is an open end, and the telescopic part is inserted into the negative pressure cavity via the open end.

8. The combined-type massager according to claim 7, wherein when the telescopic part is inserted into the negative pressure cavity, the telescopic part and the open end are attached to each other to form a sealed structure.

9. The combined-type massager according to claim 1, wherein an end of the negative pressure cavity close to the sucking part is provided with an air hole, and when the telescopic part expands and contracts, the air hole is configured for air sucking and exhausting.

10. A combined-type massager comprising a sucking massage element, wherein
the sucking massage element has at least two opposite end parts, each of the two end parts is provided with a sucking part and a negative pressure cavity, and at least part of the sucking part is located in the negative pressure cavity;
the sucking part has a concave structure and is configured as a sucking cavity, and a movable tongue part is provided in the sucking cavity;
a telescopic device capable of expanding and contracting is inserted into the negative pressure cavity, and the telescopic device is detachably connected with the negative pressure cavity; and
when the telescopic device is expanded and contracted, the negative pressure cavity and the sucking cavity generate an air pressure difference, and are able to synchronously drive the tongue part to move.

11. The combined-type massager according to claim 10, wherein the telescopic device is a telescopic massage element, which is provided with a telescopic part inserted into the negative pressure cavity.

12. The combined-type massager according to claim 11, wherein an end of the negative pressure cavity far from the sucking part is an open end, and the telescopic part is inserted into the negative pressure cavity via the open end.

13. The combined-type massager according to claim 12, wherein when the telescopic part is inserted into the negative pressure cavity, the telescopic part and the open end are attached to each other to form a sealed structure.

14. The combined-type massager according to claim 13, wherein an end of the negative pressure cavity close to the sucking part is provided with an air hole, and when the telescopic part expands and contracts, the air hole is configured for air sucking and exhausting.

15. The combined-type massager according to claim 14, wherein the telescopic part has an expanded state and a contracted state; and
when that telescopic part is in the expanded state, the air in the negative pressure cavity is exhausted; when the telescopic part is in the contracted state, the negative pressure cavity forms a negative pressure and generates an air pressure difference with the sucking cavity.

16. A combined-type massager comprising a sucking massage element, wherein
the sucking massage element has at least two opposite end parts, each of the two end parts is provided with a sucking part and an installation cavity, and at least part of the sucking part is located in the installation cavity;
the sucking part has a concave structure and is configured as a sucking cavity, and a movable tongue part is provided in the sucking cavity;
a telescopic device capable of expanding and contracting is inserted into the installation cavity, and the telescopic device is detachably connected with the installation cavity;
the telescopic device is provided with a telescopic part, and a linkage mechanism is provided between the telescopic part and the tongue part; and
when the telescopic part is expanded and contracted, the telescopic part is connected with the tongue part through the linkage mechanism and synchronously drives the tongue part to move.

17. The combined-type massager according to claim 16, wherein the telescopic device is a telescopic massage element, which comprises an intra-body massage element; and the telescopic part is disposed at an edge of an end of the intra-body massage element, and a telescopic driving mechanism is provided inside the telescopic part.

18. The combined-type massager according to claim 17, wherein the telescopic massage element further comprises an extra-body massage element, the telescopic part is disposed at an end far away from the extra-body massage element, and a first vibration motor is installed in the extra-body massage element.

19. The combined-type massager according to claim 16, wherein the linkage mechanism comprises a second vibration motor with a built-in magnet and a magnetic body installed in the telescopic part.

20. The combined-type massager according to claim 19, wherein the second vibration motor penetrates into the installation cavity and is attracted by the magnetic body inside the telescopic part.
